(19) United States
(12) Patent Application Publication
(10) Pub. No.: US 2023/0093247 A1
(43) Pub. Date: Mar. 23, 2023

(54) MEMORY ACCESS TRACKER IN DEVICE PRIVATE MEMORY

(71) Applicant: Intel Corporation, Santa Clara, CA (US)

(72) Inventors: Sanjay Kumar, Hillbsoro, OR (US); Bhargavi Narayanasetty, Portland, OR (US); Andrew Anderson, Forest Grove, OR (US); Anupama Kurpad, Portland, OR (US); Evgeny V. Voevodin, Portland, OR (US); Patrick Ndouniama, Portland, OR (US); Sai Prashanth Muralidhara, Portland, OR (US); Rajat Agarwal, Portland, OR (US); Mohamed Arafa, Chandler, AZ (US)

(73) Assignee: Intel Corporation, Santa Clara, CA (US)

(21) Appl. No.: 17/481,770

(22) Filed: Sep. 22, 2021

(51) Int. Cl. G06F 3/06

(52) U.S. Cl. CPC G06F 3/0653; G06F 3/0604; G06F 3/0673

(57) ABSTRACT

An embodiment of an integrated circuit may comprise local memory, a plurality of per-page counters located in a non-system-addressable region of the local memory, and circuitry coupled to the local memory, the circuitry to count accesses to pages of a system-addressable memory space with the plurality of per-page counters located in the non-system-addressable region of the local memory. Other embodiments are disclosed and claimed.

### BACKGROUND

### 1. Technical Field

This disclosure generally relates to memory technology, and tiered memory technology.

### 2. Background Art

Tiered memory systems include heterogeneous memory where a first memory tier generally has lower latency with lower capacity and a second memory tier generally has higher capacity with higher latency. Migration technology includes a wide variety of techniques utilized to efficiently move data between the first and second memory tiers. In some systems, the first memory tier may be referred to as near memory (NM) and the second memory tier may be referred to as far memory (FM).

Some graphics processor units (GPUs) include an access counter feature that keep track of the frequency of access that a GPU makes to memory located on other processors. The access counters are described as helping to ensure memory pages are moved to the physical memory of the processor that is accessing the pages most frequently.

### BRIEF DESCRIPTION OF THE DRAWINGS

The various embodiments of the present invention are illustrated by way of example, and not by way of limitation, in the figures of the accompanying drawings and in which:

FIG. 1 is a block diagram of an example of an integrated circuit according to an embodiment;

FIGS. 2A to 2C are flow diagrams of an example of a method according to an embodiment;

FIG. 3 is a block diagram of an example of an apparatus according to an embodiment;

FIG. 4 is a block diagram of an example of a far memory (FM) device according to an embodiment;

FIG. 5 is a block diagram of another example of a FM device according to an embodiment;

FIG. 6 is a block diagram of another example of a FM device according to an embodiment;

FIG. 7 is a block diagram of another example of a FM device according to an embodiment;

FIG. 8 is a block diagram of another example of a FM device according to an embodiment;

FIG. 9 is a block diagram of another example of a FM device according to an embodiment;

FIG. 10A is a block diagram illustrating both an exemplary in-order pipeline and an exemplary register renaming, out-of-order issue/execution pipeline according to embodiments of the invention.

FIG. 10B is a block diagram illustrating both an exemplary embodiment of an in-order architecture core and an exemplary register renaming, out-of-order issue/execution architecture core to be included in a processor according to embodiments of the invention;

FIGS. 11A-B illustrate a block diagram of a more specific exemplary in-order core architecture, which core would be one of several logic blocks (including other cores of the same type and/or different types) in a chip;

FIG. 12 is a block diagram of a processor that may have more than one core, may have an integrated memory controller, and may have integrated graphics according to embodiments of the invention;

FIGS. 13-16 are block diagrams of exemplary computer architectures; and

FIG. 17 is a block diagram contrasting the use of a software instruction converter to convert binary instructions in a source instruction set to binary instructions in a target instruction set according to embodiments of the invention.

### DETAILED DESCRIPTION

Embodiments discussed herein variously provide techniques and mechanisms for hardware assisted memory access tracking. The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including integrated circuitry which is operable to provide hardware assisted memory access tracking.

In the following description, numerous details are discussed to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

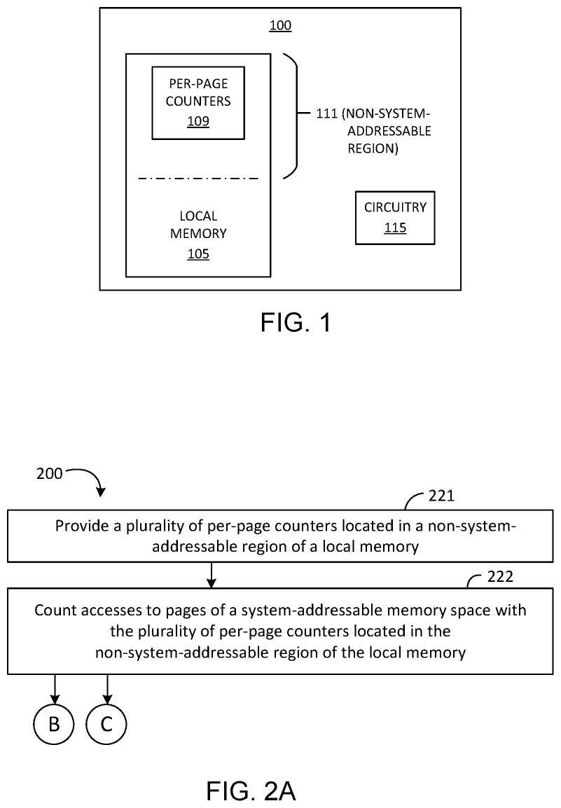

With reference to FIG. 1, an embodiment of an integrated circuit 100 may include local memory 105, a plurality of per-page counters 109 located in a non-system-addressable region 111 of the local memory 105, and circuitry 115 coupled to the local memory 105. The circuitry 115 may be configured to count accesses to pages of a system-addressable memory space with the plurality of per-page counters 109 located in the non-system-addressable region 111 of the local memory 105. In some embodiments, the circuitry 115 may also be configured to report information that corresponds to the plurality of per-page counters 109. For example, the circuitry 115 may be configured to maintain one or more shadow configuration registers based on the contents of the one or more configuration registers of a core, and to count the accesses to the pages of the system-addressable memory space in accordance with information stored in the one or more shadow configuration registers. For example, system-addressable memory space is visible to an operating system (OS) while the non-system-addressable region 111 of the local memory 105 is not visible to the OS.

In some embodiments, the circuitry 115 may be configured to associate respective timestamps with the plurality of per-page counters 109. For example, the circuitry 115 may be configured to store respective per-page counter values and per-page timestamp values for the pages of the system-addressable memory space together with respective address indirection table (AIT) entries in the non-system-addressable region 111 of the local memory 105. In some embodiments, the circuitry 115 may also be configured to increment a global timer value after a pre-defined period of time, and to adjust one or more of the per-page counter values 109 based on the associated per-page timestamp value and the global timer value. For example, the circuitry 115 may be configured to apply a leak function to a per-page counter value based on the associated per-page timestamp value and the global timer value when a page associated with the per-page counter is accessed.

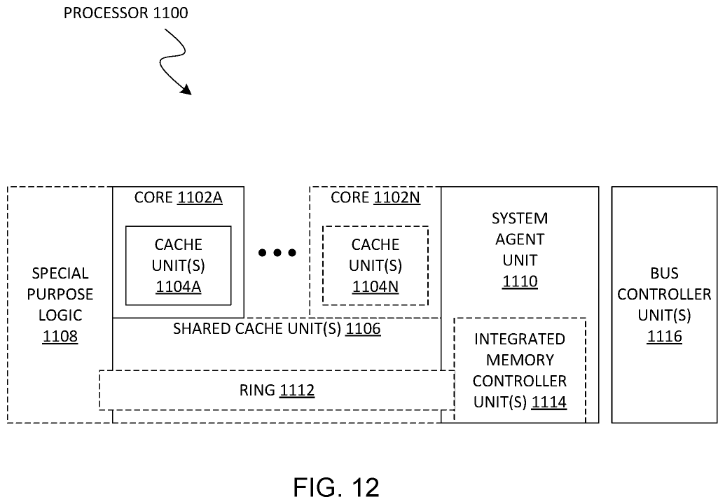

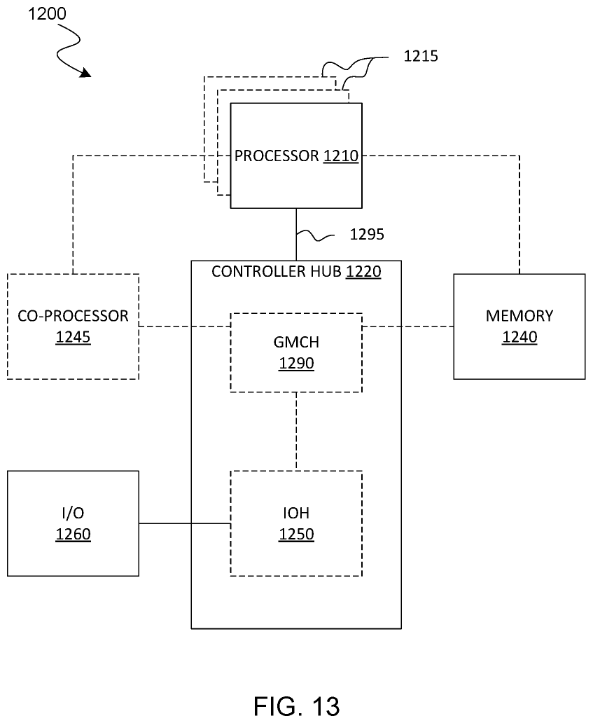

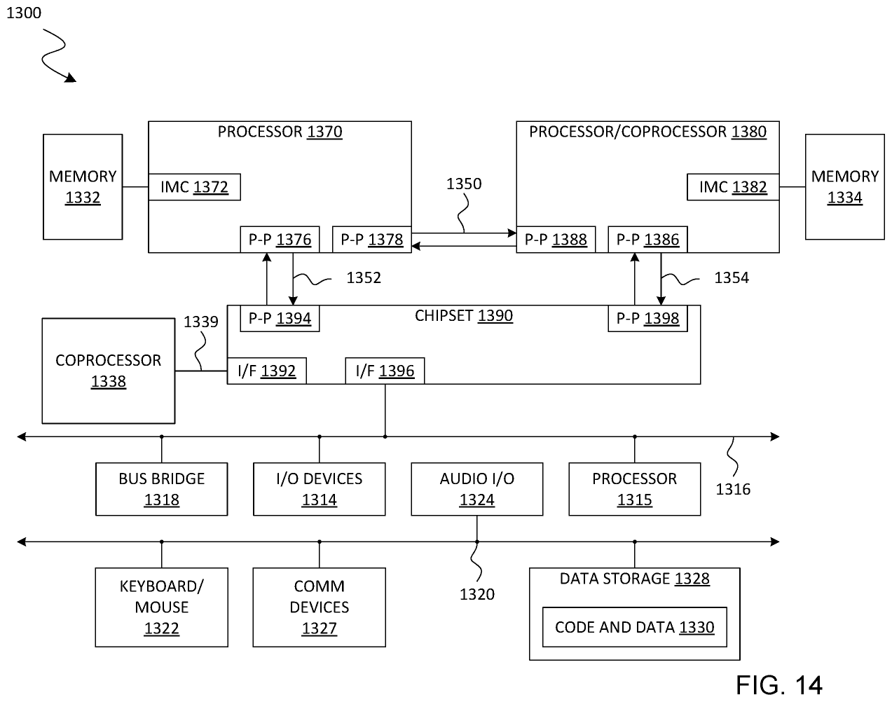

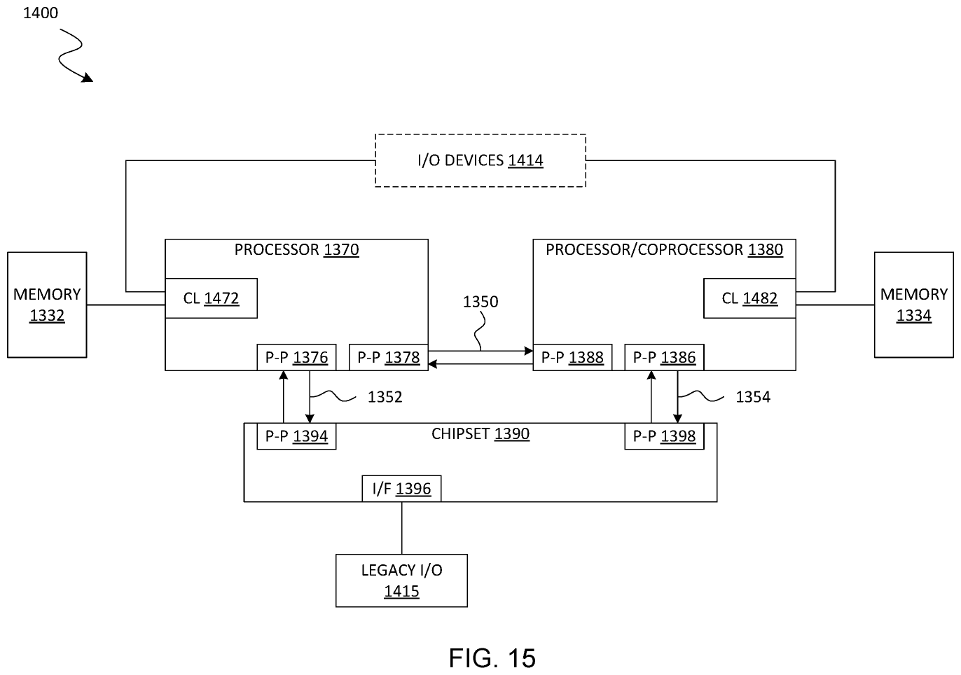

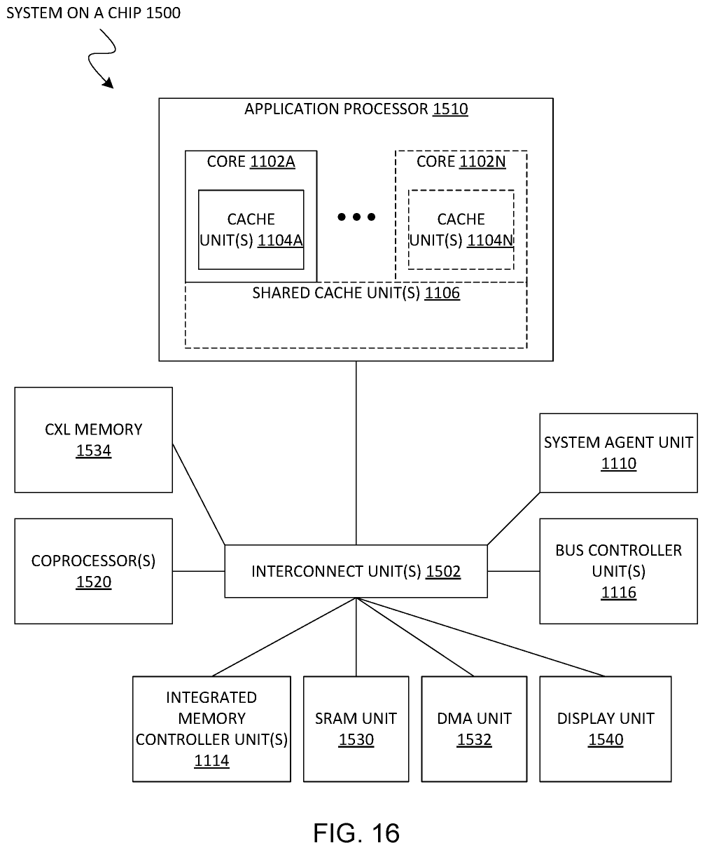

Embodiments of the integrated circuit 100, including the local memory 105, the per-page counters 109, and/or the circuitry 115, may be incorporated in a memory controller or memory device including, for example, the integrated memory controller unit 1114 (FIG. 12), the memory 1240 and/or GMCH 1290 (FIG. 13), the memory 1332, 1334, IMCs 1372, 1382, and/or data storage 1328 (FIGS. 14-15), and/or the integrated memory controller unit 1114, SRAM unit 1530, and/or direct memory access (DMA) unit 1532 (FIG. 16).

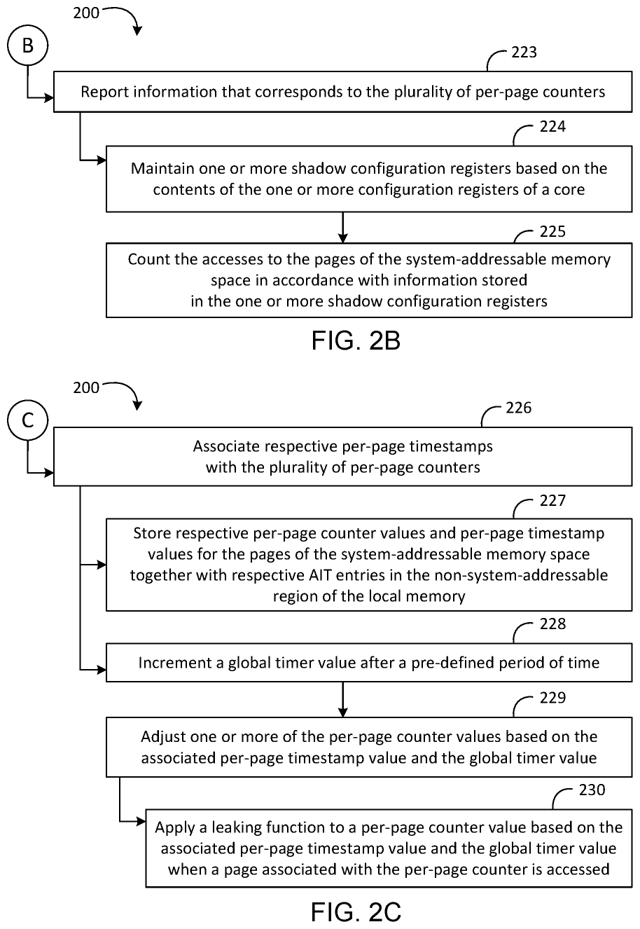

With reference to FIGS. 2A to 2C, an embodiment of a method 200 may include providing a plurality of per-page counters located in a non-system-addressable region of a local memory at box 221, and counting accesses to pages of a system-addressable memory space with the plurality of per-page counters located in the non-system-addressable region of the local memory at box 222. Some embodiments of the method 200 may further include reporting information that corresponds to the plurality of per-page counters at box 223. For example, the method 200 may include maintaining one or more shadow configuration registers based on the contents of the one or more configuration registers of a core at box 224, and counting the accesses to the pages of the system-addressable memory space in accordance with information stored in the one or more shadow configuration registers at box 225.

Some embodiments of the method 200 may further include associating respective timestamps with the plurality of per-page counters at box 226. For example, the method 200 may include storing respective per-page counter values and per-page timestamp values for the pages of the system-addressable memory space together with respective AIT entries in the non-system-addressable region of the local memory at box 227. The method 200 may also include incrementing a global timer value after a pre-defined period of time at box 228, and adjusting one or more of the per-page counter values based on the associated per-page timestamp value and the global timer value at box 229. For example, the method 200 may include applying a leaking function to a per-page counter value based on the associated per-page timestamp value and the global timer value when a page associated with the per-page counter is accessed at box 230.

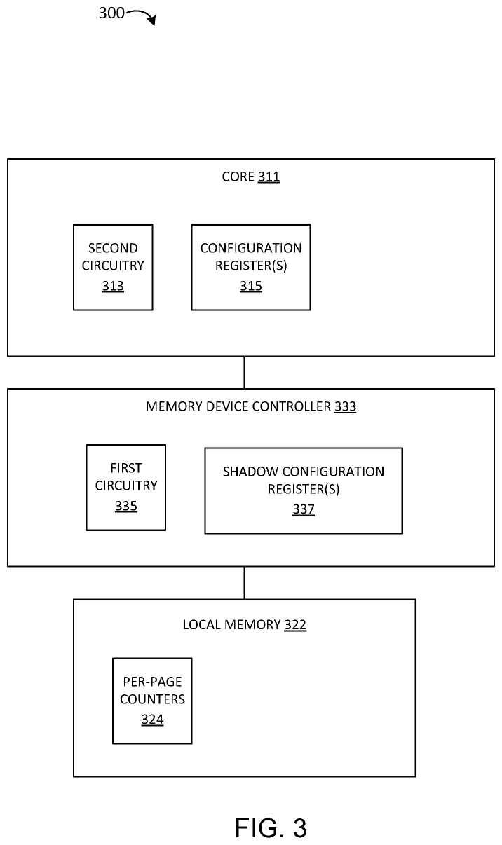

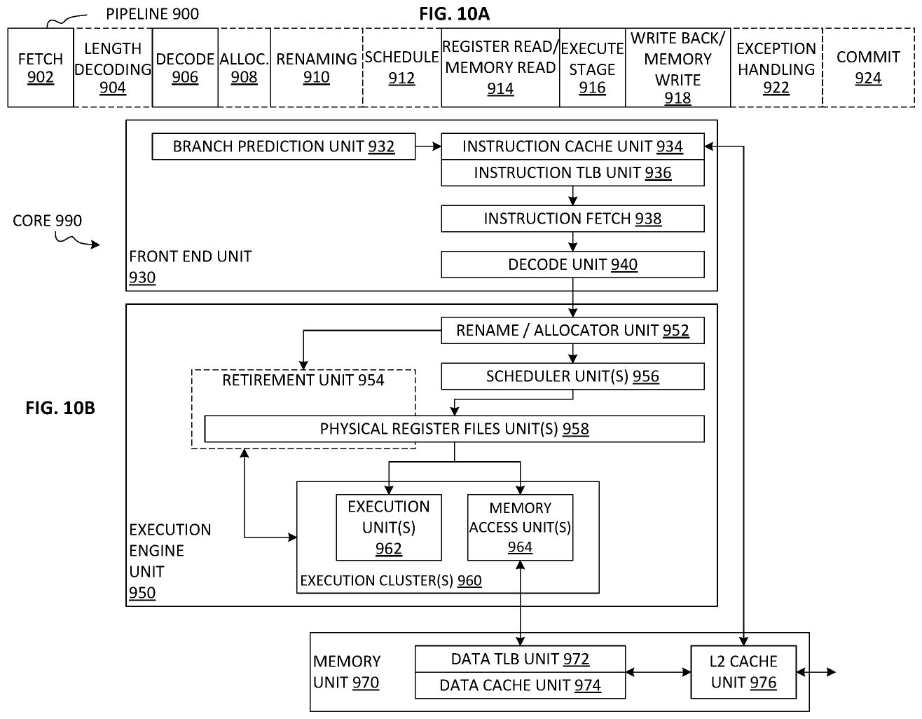

Embodiments of the method 200 may be performed by any suitable electronic apparatus or system such as, for example, the integrated circuit 100 (FIG. 1), the apparatus 300 (FIG. 3), and/or any of the processors, memory controllers, and/or memory devices described in FIG. 10A through FIG. 18.

With reference to FIG. 3, an embodiment of an apparatus 300 may include a core 311, a local memory 322, and a memory device controller 333 coupled to the core 311 and the local memory 322. The memory device controller 333 may include first circuitry 335 to count accesses to pages of a system-addressable memory space with a plurality of per-page counters 324 located in a non-system-addressable region of the local memory 322. The apparatus 300 may further include second circuitry 313 to report information that corresponds to the plurality of per-page counters, where the second circuitry 313 may be co-located with the core 311. For example, the core 311 may further comprise one or more configuration registers 315, the memory device controller 333 may further comprise one or more shadow configuration registers 337, and the first circuitry 335 may be configured to maintain the one or more shadow configuration registers 337 based on the contents of the one or more configuration registers 315, and to count the accesses to the pages of the system-addressable memory space in accordance with information stored in the one or more shadow configuration registers 337. In other embodiments, all or portions of the second circuitry 313 may be co-located with one or more of the local memory 322 and the memory device controller 333.

In some embodiments, the first circuitry 335 may be configured to associate respective per-page timestamps with the plurality of per-page counters 324. For example, the first circuitry 335 may be configured to store respective per-page counter values and per-page timestamp values for the pages of the system-addressable memory space together with respective AIT entries in the non-system-addressable region of the local memory 322. In some embodiments, the first circuitry 335 may be further configured to increment a global timer value after a pre-defined period of time, and adjust one or more of the per-page counter values based on the associated per-page timestamp value and the global timer value. For example, the first circuitry 335 may be configured to apply a leak function to a per-page counter value based on the associated per-page timestamp value and the global timer value when a page associated with the per-page counter is accessed.

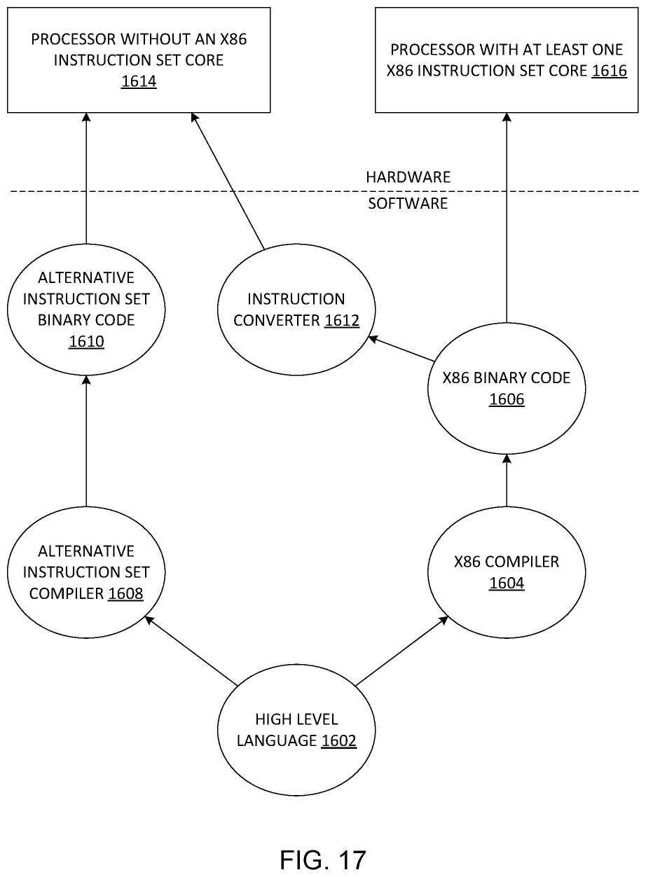

Non-limiting example implementations of the core 311 include the core 990 (FIG. 10B), the cores 1102A-N (FIGS. 12, 16), the processor 1210 (FIG. 13), the co-processor 1245 (FIG. 13), the processor 1370 (FIGS. 14-15), the processor/coprocessor 1380 (FIGS. 14-15), the coprocessor 1338 (FIGS. 14-15), the coprocessor 1520 (FIG. 16), and/or the processors 1614, 1616 (FIG. 17).

Some embodiments provide technology for a memory access tracker for a FM (FM) tier of a multi-level memory system. In tiered memory systems, NM (NM) may refer to higher performance memory and FM may refer to lower performance memory relative to the NM. NM and FM both are central processor unit (CPU) accessible and cacheable and can be used as normal system memory. A software application or agent (e.g., an operating system (OS)) memory manager generally implements a policy to keep frequently accessed (e.g., sometimes referred to as ‘hot’) pages in NM and infrequently accessed (e.g., sometimes referred to as ‘cold’) pages in FM. For example, an OS memory manager may perform hot and cold page tracking at run time and migrate hot pages from FM to NM and cold pages from NM to FM.

In a two-level memory (2LM) system, a hardware based 2LM controller may manage the NM as a cache of the FM (e.g., transparent to software). If the NM cache is implemented as a direct-mapped cache (e.g., INTEL OPTANE DC PERSISTENT MEMORY in Memory Mode), the NM cache may incur high conflict for certain workloads (e.g., if two hot FM cachelines map to the same NM cacheline). The OS memory manager may attempt to detect such high conflict pages and migrate them either within the 2LM memory or to one-level memory (1LM) NM to resolve/reduce the conflicts.

An example of a tiered memory system includes a system with local DRAM for NM and Compute Express Link (CXL) attached persistent memory (e.g., INTEL OPTANE) for FM. As used herein, a device that contains the FM may be referred to as a memory device or a FM device (e.g., a CXL device with CXL.mem memory). Some embodiments may provide efficient hardware technology to provide page-granular memory access tracking to determine hot pages in FM (e.g., CXL memory) and to notify the hot pages to the OS/software so that the OS/software can migrate the hot pages to NM and improve overall performance of the system. Some embodiments provide memory access tracker (MAT) technology that works in both 1LM and 2LM configurations. In one embodiment, 1 MAT device may be associated with each memory device (e.g., FM memory device). In 1LM, the FM MAT detects hot pages and in a 2LM region, the FM MAT detects high conflict pages. Although embodiments are described below using CXL memory as an example, those skilled in the art will appreciate that embodiments may be applied to other memory configurations and other FM links (e.g., Cache Coherent NVLINK, Cache Coherent Interconnect for Accelerators (CCIX), etc.).

A conventional OS memory manager may use two sources of page access information from hardware to do their applications' hot/cold page tracking in 1LM systems. One source includes periodically scanning/clearing of Access/Dirty (A/D) bits in CPU page tables (e.g., both first level and second level page tables) to determine cold pages. A second source includes periodically inducing page faults in applications by unmapping FM pages in application page tables to determine hot pages. Using page faults or frequent A/D bit scanning to do hot page tracking, however, has high overhead. Another problem is that neither source counts last-level cache (LLC) misses. Both page fault and A/D bit information don't indicate which accesses are missing the CPU caches and incurring the FM latency. Counting LLC misses are better so that CPU cache friendly FM cachelines don't need to be migrated to NM. Another problem is that both page fault and A/D bit information doesn't provide useful information about 2LM cache misses and accordingly doesn't help the OS to detect conflicting cachelines in a direct mapped 2LM cache.

Some embodiments provide efficient MAT device technology for FM to overcome one or more of the foregoing problems. To count memory access at page granularity in a MAT, some embodiments implement per-page counters in device private memory (e.g., a region of memory that is not visible to the OS/software/applications) in the memory device. A software visible interface of the MAT may be implemented either in the processor (e.g., a CPU system-on-chip (SoC), in or near a CXL root port) or the software visible interface may be implemented in the memory device itself for greater flexibility. Some embodiments may implement a MAT hot-page reporting structure in device private memory or device silicon (e.g., instead of in system memory) that can be accessed by software (e.g., using memory mapped input/output (MMIO) accesses).

Advantageously, by implementing per-page counters in device private memory, embodiments of a MAT can track accesses to all pages in memory which significantly improves efficiency and reduces overhead (compared to implementing a small number of counters in silicon). Additionally, by splitting the MAT device across a FM link (e.g., with counters in the memory device and a software interface in the CPU SoC), some embodiments may leverage device private memory for counters and implement a MAT hardware/software interface in the CPU that is consistent for a wide variety of FM devices. Alternatively, by implementing the MAT device completely in the memory device (e.g., the counters as well as the software visible interface), some embodiments may keep the MAT device independent of any CPU SoC support. Another advantage is that, by implementing the hot-page reporting structure in device private memory or device silicon (e.g., instead of system memory), some embodiments may avoid the need to build a DMA controller in the memory device.

Another advantage is that some embodiments of counting technology offloads the page access counting from software which significantly reduces software overhead. Moreover, the hardware counting may be more accurate and the software may be better able to determine hot and cold pages and perform more effective page migrations between different memory tiers to optimize application performance. For example, software doesn't need to scan/clear page table A/D bits or induce page-faults to count accesses. Embodiments of the hardware counting technology can be configured to provide a list of hot pages to software which significantly reduces the software's overhead for determining the hot pages (e.g., for migration from one memory tier to another memory tier).

Some embodiments provide technology for a MAT device that is located on the FM access path and configured to detect hot pages in FM. Logically, a MAT device may include a counting component and a reporting component. The counting component (e.g., also referred to as a hardware counter set (HCS)) is not software visible and contains counters that count memory accesses at a page granularity (e.g., each counter counts accesses to a single page). The reporting component (e.g., also referred to as the software visible interface) contains the MAT device's registers that software can read/write to program the device as well. The reporting component may also include a reporting structure (e.g., referred to as a notification queue (NFQ)) to notify hot page addresses to software.

### Examples of Per-Page Counters in Device Private Memory

A MAT device may implement a counter for every page in the device private memory. Having a counter for every page may provide better hot-page detection because the MAT device can count all page accesses simultaneously. Because the counters are implemented in device private memory, embodiments may be much less expensive as compared to implementing the counters in device silicon. For example, for each four kilobyte (4 KB) page, an 8-bit counter implemented in device private memory may utilize minimal space overhead.

In some embodiments, on a FM access, the MAT device is configured to read the corresponding counter from device private memory, increment the counter, and check the value against the hot-page threshold. If the count is greater than the threshold, the page address is notified to the OS via the NFQ and the counter is initialized to 0. Then, the new counter value is written back to the corresponding location in device private memory.

Such counter implementation can cause frequent reads/writes to device private memory because every FM access would require a read and a write to the corresponding page's counter. In some embodiments, a MAT device may significantly reduce the memory traffic for counter access by using a cache of counters in silicon. Embodiments of a MAT device may also reduce memory traffic for reading/writing counters by counting a smaller percentage of FM accesses (e.g., instead of counting 100% FM access). For example, the MAT device may support a software configurable “sampling rate” parameter (e.g., that may be programmed in a MAT register) that controls what percentage of memory accesses are counted.

Some embodiments may embed a MAT device's per-page counters in another per-page data structures in device private memory. For example, some controller devices may utilize an AIT in device private memory that includes entries to translate a host physical address (HPA) to a device private address (DPA). In some embodiments, the MAT counters may be embedded in the AIT table entries to create per-page counters with minimal overhead.

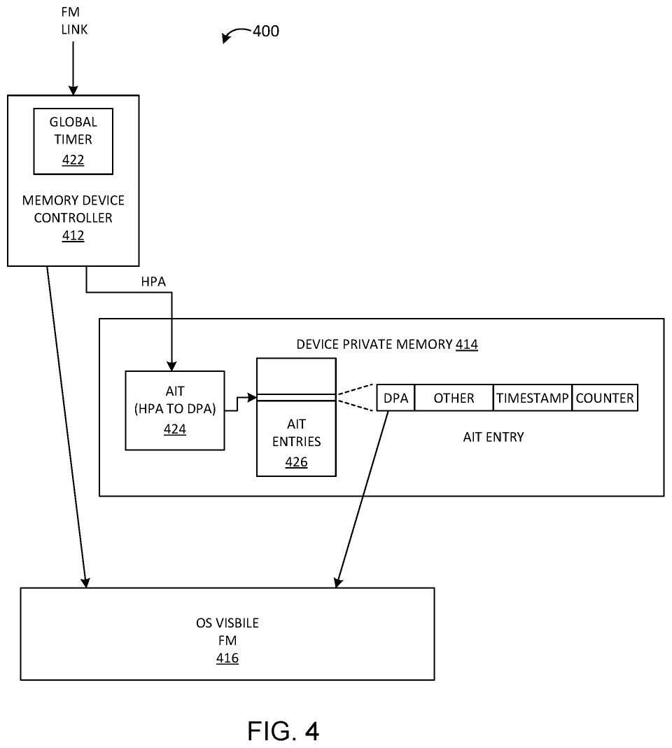

With reference to FIG. 4, an embodiment of a FM device 400 includes a memory device controller 412 coupled to device private memory 414 (e.g., non-system-addressable memory) and OS visible FM 416 (e.g., system-addressable memory). The FM device 400 may be coupled to a server or computer system via a FM link. The memory device controller 412 includes a global timer 422. The device private memory 414 includes an AIT 424 to translate HPAs to DPAs. Example AIT entries 426 may be indexed by the HPA of an access request to the FM device 400 and each AIT entry may include fields for the DPA and other AIT-specific information. In accordance with some embodiments, the AIT entry may further include fields for a counter value and a timestamp value associated with the page addressed by the HPA. The timestamp records the time of last access to the corresponding page. On each FM access, the memory device controller 412 reads the AIT table entry for the HPA to determine the DPA. In some embodiments, the corresponding counter is read along with the AIT entry (e.g., a free counter read), the counter value and timestamp value are then updated and written back to the AIT entry. In some embodiments, the MAT counts both read and write accesses. In other embodiments, the MAT may count only write accesses, or only read accesses.

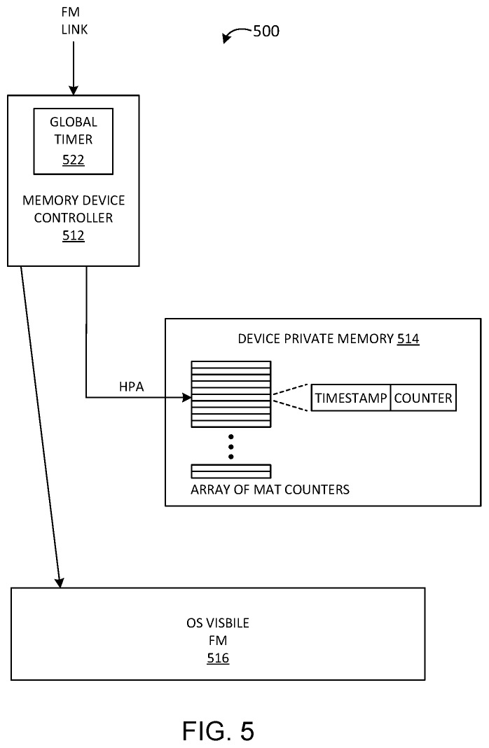

With reference to FIG. 5, an embodiment of a FM device 500 includes a memory device controller 512 coupled to device private memory 514 and OS visible FM 516. The FM device 500 may be coupled to a server or computer system via a FM link. The memory device controller 512 includes a global timer 522. The device private memory 514 includes a dedicated structure in device private memory 514 (e.g., an array of MAT counters) to implement per-page counters. In accordance with some embodiments, the array of MAT counters may include fields for a counter value and a timestamp value associated with the page addressed by the HPA. On each FM access, the memory device controller 412 reads the array entry for the HPA, the counter value and timestamp value are then updated and written back to the array entry. In some embodiments, the MAT counts both read and write accesses. In other embodiments, the MAT may count only write accesses, or only read accesses.

For any of the embodiments described herein, a MAT device may also support periodic leaking of the counters to ensure the counts represent recent accesses. For example, software may configure a suitable time period (e.g., an epoch) for the periodic leaking as well as the leaking function. Non-limiting examples of suitable leaking functions include: reset the counter to 0; divide the counter by 2; etc.

In some embodiments, at the end of each epoch, the MAT device can walk through the set of all counters and apply the leaking function. However, this may cause significant processing overhead as the number of counters may be large. In other embodiments, the MAT device may implement on-access leaking of counters where the counter values are reduced only when they are accessed. For example, as shown in FIGS. 4 and 5, a MAT device may maintain a timestamp field along with the counter field in each counter. The timestamp field stores a timestamp value that indicates the time when the page was last accessed. As shown in FIGS. 4 and 5, a MAT device may also maintain a global timer that increments after each epoch. On a new access to a page, the MAT device may determine the elapsed time since the page was last accessed by comparing the timestamp value for the counter with a global timer value. The MAT device may then reduce the counter value based on the elapsed time, epoch interval, and leaking function. For example, if the leaking function is “divide the counter by 2”, and 4 epochs have passed in the elapsed time, the MAT device divides the counter by 16 (e.g., before adding 1 for the current access). If the timestamp for the counter wraps around (e.g., for a 4-bit timestamp, after 16 epochs the counter will wrap around), the MAT device may sweep through all counters and apply the leaking function on all counters. Embodiments may provide more efficient counter leaking because the MAT device doesn't have to sweep through all counters at the end of each epoch.

### Examples of a MAT Reporting Component

As described above, embodiments of a MAT device's counting component (e.g., a HCS) is generally implemented in device private memory. However, embodiments of a MAT device's reporting component may be implemented either on the device side or on the CPU SoC side, advantageously providing flexibility for the implementation as may be more suitable for a particular system.

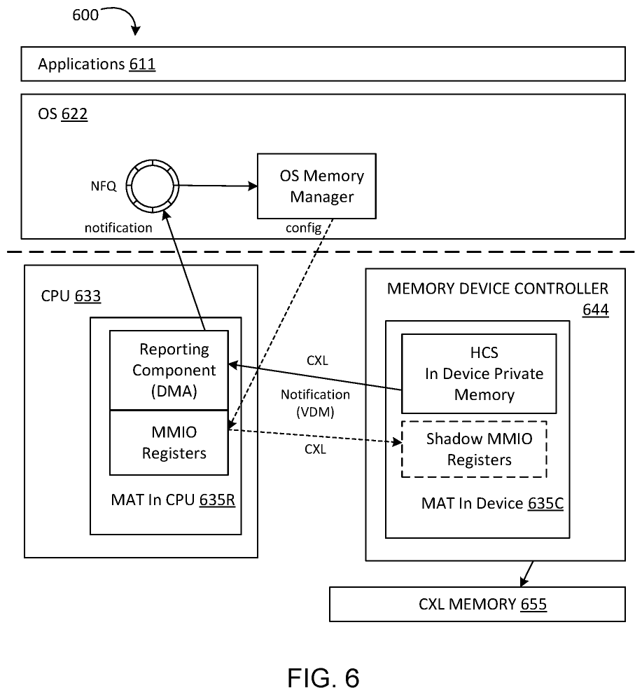

With reference to FIG. 6, an embodiment of a system 600 may include software (e.g., applications 611, an OS 622, etc.) nominally illustrated above the dashed line and hardware (e.g., CPU 633, memory device controller 644, CXL memory 655, etc.) nominally illustrated below the dashed line. The OS 622 includes an OS memory manger and maintains a NFQ. The CPU 633 includes a portion of a MAT device 635R with a reporting component and MMIO registers. The memory device controller 644 includes another portion of the MAT device 635C with HCS in device private memory and shadow MMIO registers. As shown in FIG. 6, a MAT implementation has the reporting component (and MMIO registers) implemented on the CPU side (e.g., at a CXL root port). For example, a split between a CPU SoC and a memory device provides greater flexibility because it allows the MAT device to store per-page counters in device private memory and also provide a consistent hardware/software interface on the CPU SoC side.

In some embodiments, hot-page notifications from the counting component are sent to the reporting component via standard messages on a FM link (e.g., a CXL link). On CXL, for example, a MAT device can use a Vendor Defined Message (VDM) to notify hot-page addresses to the reporting component. The reporting component can then utilize a DMA operation to provide the hot-page addresses to the NFQ in system memory.

In this embodiment, software only interacts with the CPU side of the MAT device. The OS/software configures any registers on the CPU side. Some or all of these registers are shadowed (e.g., a copy is created) on the memory device side as well because the counting component also needs access to information in those registers. For example, a hot-page threshold register may be utilized on the memory device side to compare against the counter values.

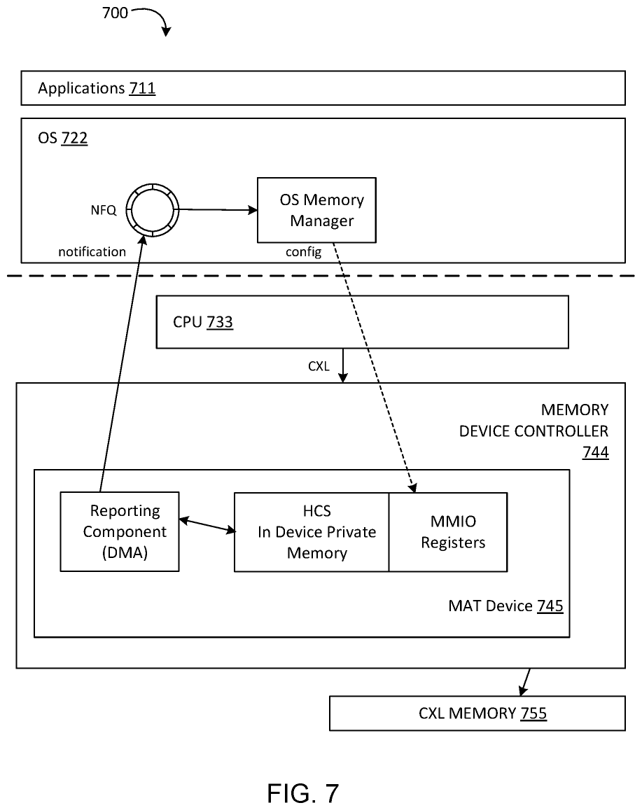

With reference to FIG. 7, an embodiment of a system 700 may include software (e.g., applications 711, an OS 722, etc.) nominally illustrated above the dashed line and hardware (e.g., CPU 733, memory device controller 744, CXL memory 755, etc.) nominally illustrated below the dashed line. The OS 722 includes an OS memory manger and maintains a NFQ. The memory device controller 744 includes the entire MAT device 745 with HCS in device private memory, a reporting component, and MMIO registers. As shown in FIG. 7, a MAT implementation has the reporting component (and MMIO registers) implemented on the memory device side. With the MAT device 745 fully contained in the memory device, the access counting doesn't depend on any support from the CPU side.

### Examples of a MAT Reporting Structure

The above examples describe a hot-page reporting structure or a NFQ in system memory, where the MAT device reports hot pages by performing DMA to the NFQ and sending an interrupt to the OS. On receiving the interrupt, the OS reads the hot-page addresses from the NFQ and performs page migrations (e.g., from FM to NM) based on its policies. However, in some embodiments, the NFQ may be implemented in the memory device, either in device silicon or in device private memory.

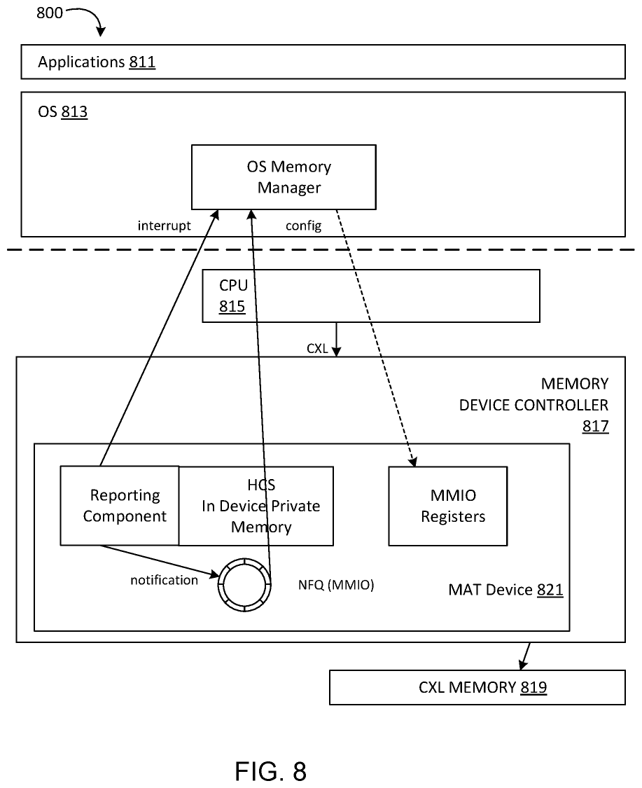

With reference to FIG. 8, an embodiment of a system 800 may include software (e.g., applications 811, an OS 813, etc.) nominally illustrated above the dashed line and hardware (e.g., CPU 815, memory device controller 817, CXL memory 819, etc.) nominally illustrated below the dashed line. The OS 813 includes an OS memory manger (e.g., but no NFQ). The memory device controller 817 includes the entire MAT device 821 with HCS in device private memory, a reporting component, and MMIO registers. As shown in FIG. 8, the MAT device 821 further includes the NFQ implemented on the memory device side. The NFQ is exposed to software via MMIO registers. Software can read the NFQ contents by performing MMIO reads. This embodiment allows the flexibility to avoid implementing a DMA controller in the MAT device 821.

For some systems, MMIO accesses to the NFQ may not provide sufficient performance. In some embodiments, to improve the performance of NFQ accesses, software can use a DMA controller in the CPU SoC (e.g., which may already be present in the CPU). For example, some compute platforms may include a DMA engine or a data streaming accelerator (DSA) that may be utilized by software to read NFQ data from device memory to system memory with improved performance.

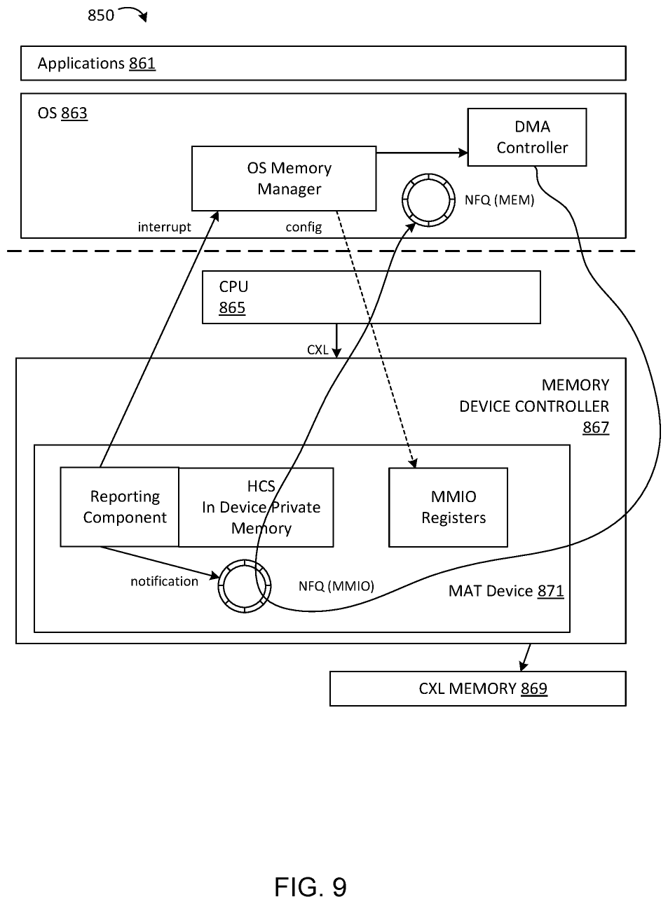

With reference to FIG. 9, an embodiment of a system 850 may include software (e.g., applications 861, an OS 863, etc.) nominally illustrated above the dashed line and hardware (e.g., CPU 865, memory device controller 867, CXL memory 869, etc.) nominally illustrated below the dashed line. The OS 863 includes an OS memory manager (e.g., but no NFQ). The memory device controller 867 includes the entire MAT device 871 with HCS in device private memory, a reporting component, MMIO registers, and the NFQ implemented on the memory device side. As shown in FIG. 9, the OS 863 further utilizes a separate DMA controller (e.g., a DSA) to read NFQ data from device memory to system memory.

### NFQ Examples

To help the OS efficiently determine hot pages, some embodiments of a MAT device reports pages and their counts to software using a memory based circular NFQ. For example, software may configure the base, size, head, and tail of the queue before enabling the MAT device. The MAT device then enqueues the notifications at a tail index and increments the tail. If the NFQ is full, new notifications are dropped. Software consumes the notifications from the head index.

When the MAT device needs to notify a hot page to software (e.g., when either a page access count reaches a MAX threshold), the MAT device prepares a notification descriptor (e.g., containing the page address and its associated count) and writes the notification descriptor into the NFQ. In some embodiments, a MAT device may support generating an in-band interrupt (e.g., a Message Signaled Interrupt (MSI)) when a hot page notification is added to the NFQ. The MAT device may also support an interrupt threshold to control batching of interrupts. When inserting a descriptor into the NFQ, for example, if the number of notification descriptors in the queue reaches the interrupt threshold, an interrupt is generated by the MAT device. Otherwise the interrupt generation is skipped. The interrupt threshold helps reduce the number of interrupts to the software. After writing the notification descriptor into the NFQ, in some embodiments, the MAT device will reset the HCS counter to zero (0).

Advantageously, an OS/virtual machine monitor (VMM) can efficiently determine the list of hot pages by reading the NFQ. The OS/VMM may process the NFQ on demand, after receiving an interrupt, etc. For example, an interrupt handler may start a kernel thread that reads head and tail registers associated with the NFQ and processes descriptors starting from the head and continuing through the tail index. As part of the descriptor processing, for example, the OS may migrate a hot page from a FM tier to a NM tier.

After processing all descriptors between the head and tail, the interrupt handler updates the head register to be equal to the tail value. The interrupt handler thread may optionally read the tail register again to check if more notifications were added by MAT during the processing of previous notifications. If more descriptors are present, the interrupt handler may process the new batch of descriptors before returning. For example, the interrupt handler may return only when the NFQ is empty.

Those skilled in the art will appreciate that a wide variety of devices may benefit from the foregoing embodiments. The following exemplary core architectures, processors, and computer architectures are non-limiting examples of devices that may beneficially incorporate embodiments of the technology described herein.

Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

Exemplary Core Architectures

In-Order and Out-of-Order Core Block Diagram

FIG. 10A is a block diagram illustrating both an exemplary in-order pipeline and an exemplary register renaming, out-of-order issue/execution pipeline according to embodiments of the invention. FIG. 10B is a block diagram illustrating both an exemplary embodiment of an in-order architecture core and an exemplary register renaming, out-of-order issue/execution architecture core to be included in a processor according to embodiments of the invention. The solid lined boxes in FIGS. 10A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 10A, a processor pipeline 900 includes a fetch stage 902, a length decode stage 904, a decode stage 906, an allocation stage 908, a renaming stage 910, a scheduling (also known as a dispatch or issue) stage 912, a register read/memory read stage 914, an execute stage 916, a write back/memory write stage 918, an exception handling stage 922, and a commit stage 924.

FIG. 10B shows processor core 990 including a front end unit 930 coupled to an execution engine unit 950, and both are coupled to a memory unit 970. The core 990 may be a reduced instruction set computing (RISC) core, a complex instruction set computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front end unit 930 includes a branch prediction unit 932 coupled to an instruction cache unit 934, which is coupled to an instruction translation lookaside buffer (TLB) 936, which is coupled to an instruction fetch unit 938, which is coupled to a decode unit 940. The decode unit 940 (or decoder) may decode instructions, and generate as an output one or more micro-operations, micro-code entry points, microinstructions, other instructions, or other control signals, which are decoded from, or which otherwise reflect, or are derived from, the original instructions. The decode unit 940 may be implemented using various different mechanisms. Examples of suitable mechanisms include, but are not limited to, look-up tables, hardware implementations, programmable logic arrays (PLAs), microcode read only memories (ROMs), etc. In one embodiment, the core 990 includes a microcode ROM or other medium that stores microcode for certain macroinstructions (e.g., in decode unit 940 or otherwise within the front end unit 930). The decode unit 940 is coupled to a rename/allocator unit 952 in the execution engine unit 950.

The execution engine unit 950 includes the rename/allocator unit 952 coupled to a retirement unit 954 and a set of one or more scheduler unit(s) 956. The scheduler unit(s) 956 represents any number of different schedulers, including reservations stations, central instruction window, etc. The scheduler unit(s) 956 is coupled to the physical register file(s) unit(s) 958. Each of the physical register file(s) units 958 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 958 comprises a vector registers unit, a write mask registers unit, and a scalar registers unit. These register units may provide architectural vector registers, vector mask registers, and general purpose registers. The physical register file(s) unit(s) 958 is overlapped by the retirement unit 954 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 954 and the physical register file(s) unit(s) 958 are coupled to the execution cluster(s) 960. The execution cluster(s) 960 includes a set of one or more execution units 962 and a set of one or more memory access units 964. The execution units 962 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 956, physical register file(s) unit(s) 958, and execution cluster(s) 960 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 964). It should also be understood that where separate pipelines are used, one or more of these pipelines may be out-of-order issue/execution and the rest in-order.

The set of memory access units 964 is coupled to the memory unit 970, which includes a data TLB unit 972 coupled to a data cache unit 974 coupled to a level 2 (L2) cache unit 976. In one exemplary embodiment, the memory access units 964 may include a load unit, a store address unit, and a store data unit, each of which is coupled to the data TLB unit 972 in the memory unit 970. The instruction cache unit 934 is further coupled to a level 2 (L2) cache unit 976 in the memory unit 970. The L2 cache unit 976 is coupled to one or more other levels of cache and eventually to a main memory.

By way of example, the exemplary register renaming, out-of-order issue/execution core architecture may implement the pipeline 900 as follows: 1) the instruction fetch 938 performs the fetch and length decoding stages 902 and 904; 2) the decode unit 940 performs the decode stage 906; 3) the rename/allocator unit 952 performs the allocation stage 908 and renaming stage 910; 4) the scheduler unit(s) 956 performs the schedule stage 912; 5) the physical register file(s) unit(s) 958 and the memory unit 970 perform the register read/memory read stage 914; the execution cluster 960 perform the execute stage 916; 6) the memory unit 970 and the physical register file(s) unit(s) 958 perform the write back/memory write stage 918; 7) various units may be involved in the exception handling stage 922; and 8) the retirement unit 954 and the physical register file(s) unit(s) 958 perform the commit stage 924.

The core 990 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 990 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 934/974 and a shared L2 cache unit 976, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

Specific Exemplary In-Order Core Architecture

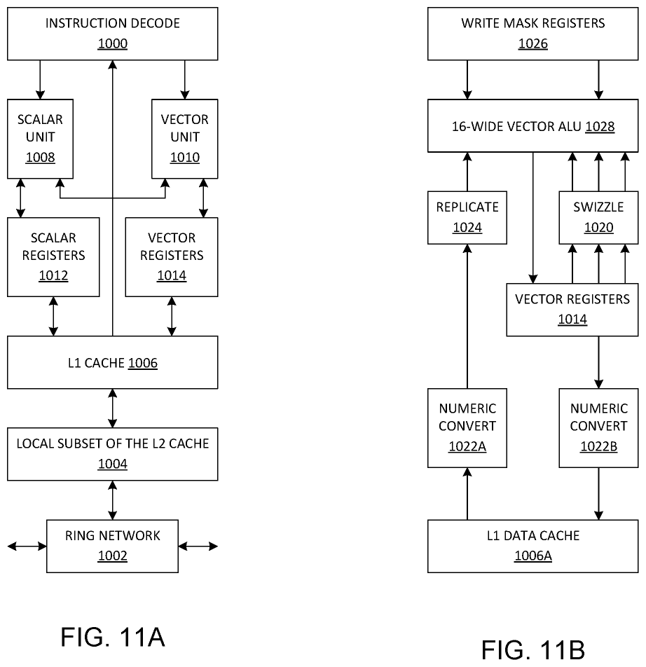

FIGS. 11A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 11A is a block diagram of a single processor core, along with its connection to the on-die interconnect network 1002 and with its local subset of the Level 2 (L2) cache 1004, according to embodiments of the invention. In one embodiment, an instruction decoder 1000 supports the x86 instruction set with a packed data instruction set extension. An L1 cache 1006 allows low-latency accesses to cache memory into the scalar and vector units. While in one embodiment (to simplify the design), a scalar unit 1008 and a vector unit 1010 use separate register sets (respectively, scalar registers 1012 and vector registers 1014) and data transferred between them is written to memory and then read back in from a level 1 (L1) cache 1006, alternative embodiments of the invention may use a different approach (e.g., use a single register set or include a communication path that allow data to be transferred between the two register files without being written and read back).

The local subset of the L2 cache 1004 is part of a global L2 cache that is divided into separate local subsets, one per processor core. Each processor core has a direct access path to its own local subset of the L2 cache 1004. Data read by a processor core is stored in its L2 cache subset 1004 and can be accessed quickly, in parallel with other processor cores accessing their own local L2 cache subsets. Data written by a processor core is stored in its own L2 cache subset 1004 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 11B is an expanded view of part of the processor core in FIG. 11A according to embodiments of the invention. FIG. 11B includes an L1 data cache 1006A part of the L1 cache 1006, as well as more detail regarding the vector unit 1010 and the vector registers 1014. Specifically, the vector unit 1010 is a 16-wide vector processing unit (VPU) (see the 16-wide ALU 1028), which executes one or more of integer, single-precision float, and double-precision float instructions. The VPU supports swizzling the register inputs with swizzle unit 1020, numeric conversion with numeric convert units 1022A-B, and replication with replication unit 1024 on the memory input. Write mask registers 1026 allow predicating resulting vector writes.

FIG. 12 is a block diagram of a processor 1100 that may have more than one core, may have an integrated memory controller, and may have integrated graphics according to embodiments of the invention. The solid lined boxes in FIG. 12 illustrate a processor 1100 with a single core 1102A, a system agent 1110, a set of one or more bus controller units 1116, while the optional addition of the dashed lined boxes illustrates an alternative processor 1100 with multiple cores 1102A-N, a set of one or more integrated memory controller unit(s) 1114 in the system agent unit 1110, and special purpose logic 1108.

Thus, different implementations of the processor 1100 may include: 1) a CPU with the special purpose logic 1108 being integrated graphics and/or scientific (throughput) logic (which may include one or more cores), and the cores 1102A-N being one or more general purpose cores (e.g., general purpose in-order cores, general purpose out-of-order cores, a combination of the two); 2) a coprocessor with the cores 1102A-N being a large number of special purpose cores intended primarily for graphics and/or scientific (throughput); and 3) a coprocessor with the cores 1102A-N being a large number of general purpose in-order cores. Thus, the processor 1100 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1100 may be a part of and/or may be implemented on one or more substrates using any of a number of process technologies, such as, for example, BiCMOS, CMOS, or NMOS.

The memory hierarchy includes one or more levels of respective caches 1104A-N within the cores 1102A-N, a set or one or more shared cache units 1106, and external memory (not shown) coupled to the set of integrated memory controller units 1114. The set of shared cache units 1106 may include one or more mid-level caches, such as level 2 (L2), level 3 (L3), level 4 (L4), or other levels of cache, a last level cache (LLC), and/or combinations thereof. While in one embodiment a ring based interconnect unit 1112 interconnects the integrated graphics logic 1108, the set of shared cache units 1106, and the system agent unit 1110/integrated memory controller unit(s) 1114, alternative embodiments may use any number of well-known techniques for interconnecting such units. In one embodiment, coherency is maintained between one or more cache units 1106 and cores 1102-A-N.

In some embodiments, one or more of the cores 1102A-N are capable of multi-threading. The system agent 1110 includes those components coordinating and operating cores 1102A-N. The system agent unit 1110 may include for example a power control unit (PCU) and a display unit. The PCU may be or include logic and components needed for regulating the power state of the cores 1102A-N and the integrated graphics logic 1108. The display unit is for driving one or more externally connected displays.

The cores 1102A-N may be homogenous or heterogeneous in terms of architecture instruction set; that is, two or more of the cores 1102A-N may be capable of execution the same instruction set, while others may be capable of executing only a subset of that instruction set or a different instruction set.

Exemplary Computer Architectures

FIGS. 13-16 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 13, shown is a block diagram of a system 1200 in accordance with one embodiment of the present invention. The system 1200 may include one or more processors 1210, 1215, which are coupled to a controller hub 1220. In one embodiment the controller hub 1220 includes a graphics memory controller hub (GMCH) 1290 and an Input/Output Hub (IOH) 1250 (which may be on separate chips); the GMCH 1290 includes memory and graphics controllers to which are coupled memory 1240 and a coprocessor 1245; the IOH 1250 couples input/output (I/O) devices 1260 to the GMCH 1290. Alternatively, one or both of the memory and graphics controllers are integrated within the processor (as described herein), the memory 1240 and the coprocessor 1245 are coupled directly to the processor 1210, and the controller hub 1220 in a single chip with the IOH 1250.

The optional nature of additional processors 1215 is denoted in FIG. 13 with broken lines. Each processor 1210, 1215 may include one or more of the processing cores described herein and may be some version of the processor 1100.

The memory 1240 may be, for example, dynamic random access memory (DRAM), phase change memory (PCM), or a combination of the two. For at least one embodiment, the controller hub 1220 communicates with the processor(s) 1210, 1215 via a multi-drop bus, such as a frontside bus (FSB), point-to-point interface such as QuickPath Interconnect (QPI), or similar connection 1295.

In one embodiment, the coprocessor 1245 is a special-purpose processor, such as, for example, a high-throughput MIC processor, a network or communication processor, compression engine, graphics processor, GPGPU, embedded processor, or the like. In one embodiment, controller hub 1220 may include an integrated graphics accelerator.

There can be a variety of differences between the physical resources 1210, 1215 in terms of a spectrum of metrics of merit including architectural, microarchitectural, thermal, power consumption characteristics, and the like.

In one embodiment, the processor 1210 executes instructions that control data processing operations of a general type. Embedded within the instructions may be coprocessor instructions. The processor 1210 recognizes these coprocessor instructions as being of a type that should be executed by the attached coprocessor 1245. Accordingly, the processor 1210 issues these coprocessor instructions (or control signals representing coprocessor instructions) on a coprocessor bus or other interconnect, to coprocessor 1245. Coprocessor(s) 1245 accept and execute the received coprocessor instructions.

Referring now to FIG. 14, shown is a block diagram of a first more specific exemplary system 1300 in accordance with an embodiment of the present invention. As shown in FIG. 14, multiprocessor system 1300 is a point-to-point interconnect system, and includes a first processor 1370 and a second processor 1380 coupled via a point-to-point interconnect 1350. Each of processors 1370 and 1380 may be some version of the processor 1100. In one embodiment of the invention, processors 1370 and 1380 are respectively processors 1210 and 1215, while coprocessor 1338 is coprocessor 1245. In another embodiment, processors 1370 and 1380 are respectively processor 1210 coprocessor 1245.

Processors 1370 and 1380 are shown including integrated memory controller (IMC) units 1372 and 1382, respectively. Processor 1370 also includes as part of its bus controller units point-to-point (P-P) interfaces 1376 and 1378; similarly, second processor 1380 includes P-P interfaces 1386 and 1388. Processors 1370, 1380 may exchange information via a point-to-point (P-P) interface 1350 using P-P interface circuits 1378, 1388. As shown in FIG. 14, IMCs 1372 and 1382 couple the processors to respective memories, namely a memory 1332 and a memory 1334, which may be portions of main memory locally attached to the respective processors.

Processors 1370, 1380 may each exchange information with a chipset 1390 via individual P-P interfaces 1352, 1354 using point to point interface circuits 1376, 1394, 1386, 1398. Chipset 1390 may optionally exchange information with the coprocessor 1338 via a high-performance interface 1339 and an interface 1392. In one embodiment, the coprocessor 1338 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1390 may be coupled to a first bus 1316 via an interface 1396. In one embodiment, first bus 1316 may be a Peripheral Component Interconnect (PCI) bus, or a bus such as a PCI Express bus or another third generation I/O interconnect bus, although the scope of the present invention is not so limited.

As shown in FIG. 14, various I/O devices 1314 may be coupled to first bus 1316, along with a bus bridge 1318 which couples first bus 1316 to a second bus 1320. In one embodiment, one or more additional processor(s) 1315, such as coprocessors, high-throughput MIC processors, GPGPU's, accelerators (such as, e.g., graphics accelerators or digital signal processing (DSP) units), field programmable gate arrays, or any other processor, are coupled to first bus 1316. In one embodiment, second bus 1320 may be a low pin count (LPC) bus. Various devices may be coupled to a second bus 1320 including, for example, a keyboard and/or mouse 1322, communication devices 1327 and a storage unit 1328 such as a disk drive or other mass storage device which may include instructions/code and data 1330, in one embodiment. Further, an audio I/O 1324 may be coupled to the second bus 1320. Note that other architectures are possible. For example, instead of the point-to-point architecture of FIG. 14, a system may implement a multi-drop bus or other such architecture.

Referring now to FIG. 15, shown is a block diagram of a second more specific exemplary system 1400 in accordance with an embodiment of the present invention Like elements in FIGS. 14 and 15 bear like reference numerals, and certain aspects of FIG. 14 have been omitted from FIG. 15 in order to avoid obscuring other aspects of FIG. 15.

FIG. 15 illustrates that the processors 1370, 1380 may include integrated memory and I/O control logic (“CL”) 1472 and 1482, respectively. Thus, the CL 1472, 1482 include integrated memory controller units and include I/O control logic. FIG. 15 illustrates that not only are the memories 1332, 1334 coupled to the CL 1472, 1482, but also that I/O devices 1414 are also coupled to the control logic 1472, 1482. Legacy I/O devices 1415 are coupled to the chipset 1390.

Referring now to FIG. 16, shown is a block diagram of a SoC 1500 in accordance with an embodiment of the present invention. Similar elements in FIG. 12 bear like reference numerals. Also, dashed lined boxes are optional features on more advanced SoCs. In FIG. 16, an interconnect unit(s) 1502 is coupled to: an application processor 1510 which includes a set of one or more cores 1102A-N and shared cache unit(s) 1106; a system agent unit 1110; a bus controller unit(s) 1116; an integrated memory controller unit(s) 1114; a set or one or more coprocessors 1520 which may include integrated graphics logic, an image processor, an audio processor, and a video processor; an static random access memory (SRAM) unit 1530; a direct memory access (DMA) unit 1532; CXL memory 1534; and a display unit 1540 for coupling to one or more external displays. In one embodiment, the coprocessor(s) 1520 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1330 illustrated in FIG. 14, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 17 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 17 shows a program in a high level language 1602 may be compiled using an x86 compiler 1604 to generate x86 binary code 1606 that may be natively executed by a processor with at least one x86 instruction set core 1616. The processor with at least one x86 instruction set core 1616 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1604 represents a compiler that is operable to generate x86 binary code 1606 (e.g., object code) that can, with or without additional linkage processing, be executed on the processor with at least one x86 instruction set core 1616. Similarly, FIG. 17 shows the program in the high level language 1602 may be compiled using an alternative instruction set compiler 1608 to generate alternative instruction set binary code 1610 that may be natively executed by a processor without at least one x86 instruction set core 1614 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1612 is used to convert the x86 binary code 1606 into code that may be natively executed by the processor without an x86 instruction set core 1614. This converted code is not likely to be the same as the alternative instruction set binary code 1610 because an instruction converter capable of this is difficult to make; however, the converted code will accomplish the general operation and be made up of instructions from the alternative instruction set. Thus, the instruction converter 1612 represents software, firmware, hardware, or a combination thereof that, through emulation, simulation or any other process, allows a processor or other electronic device that does not have an x86 instruction set processor or core to execute the x86 binary code 1606.

Techniques and architectures for ISA opcode parameterization are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

### Additional Notes and Examples

Example 1 includes an integrated circuit, comprising local memory, a plurality of per-page counters located in a non-system-addressable region of the local memory, and circuitry coupled to the local memory, the circuitry to count accesses to pages of a system-addressable memory space with the plurality of per-page counters located in the non-system-addressable region of the local memory.

Example 2 includes the integrated circuit of Example 1, wherein the circuitry is further to report information that corresponds to the plurality of per-page counters.

Example 3 includes the integrated circuit of Example 2, wherein the circuitry is further to maintain one or more shadow configuration registers based on the contents of the one or more configuration registers of a core, and count the accesses to the pages of the system-addressable memory space in accordance with information stored in the one or more shadow configuration registers.

Example 4 includes the integrated circuit of any of Examples 1 to 3, wherein the circuitry is further to associate respective timestamps with the plurality of per-page counters.

Example 5 includes the integrated circuit of Example 4, wherein the circuitry is further to store respective per-page counter values and per-page timestamp values for the pages of the system-addressable memory space together with respective address indirection table entries in the non-system-addressable region of the local memory.

Example 6 includes the integrated circuit of any of Examples 4 to 5, wherein the circuitry is further to increment a global timer value after a pre-defined period of time, and adjust one or more of the per-page counter values based on the associated per-page timestamp value and the global timer value.

Example 7 includes the integrated circuit of Example 6, wherein the circuitry is further to apply a leak function to a per-page counter value based on the associated per-page timestamp value and the global timer value when a page associated with the per-page counter is accessed.

Example 8 includes a method, comprising providing a plurality of per-page counters located in a non-system-addressable region of a local memory, and counting accesses to pages of a system-addressable memory space with the plurality of per-page counters located in the non-system-addressable region of the local memory.

Example 9 includes the method of Example 8, further comprising reporting information that corresponds to the plurality of per-page counters.

Example 10 includes the method of Example 9, further comprising maintaining one or more shadow configuration registers based on the contents of the one or more configuration registers of a core, and counting the accesses to the pages of the system-addressable memory space in accordance with information stored in the one or more shadow configuration registers.

Example 11 includes the method of any of Examples 8 to 10, further comprising associating respective timestamps with the plurality of per-page counters.

Example 12 includes the method of Example 11, further comprising storing respective per-page counter values and per-page timestamp values for the pages of the system-addressable memory space together with respective address indirection table entries in the non-system-addressable region of the local memory.

Example 13 includes the method of any of Examples 11 to 12, further comprising incrementing a global timer value after a pre-defined period of time, and adjusting one or more of the per-page counter values based on the associated per-page timestamp value and the global timer value.

Example 14 includes the method of Example 13, further comprising applying a leaking function to a per-page counter value based on the associated per-page timestamp value and the global timer value when a page associated with the per-page counter is accessed.

Example 15 includes an apparatus, comprising a core, a local memory, and a memory device controller coupled to the core and the local memory, the memory device controller including first circuitry to count accesses to pages of a system-addressable memory space with a plurality of per-page counters located in a non-system-addressable region of the local memory.

Example 16 includes the apparatus of Example 15, further comprising second circuitry to report information that corresponds to the plurality of per-page counters.

Example 17 includes the apparatus of Example 16, wherein the second circuitry is co-located with the core.

Example 18 includes the apparatus of Example 17, wherein the core further comprises one or more configuration registers, the memory device controller further comprises one or more shadow configuration registers, and wherein the first circuitry is further to maintain the one or more shadow configuration registers based on the contents of the one or more configuration registers, and count the accesses to the pages of the system-addressable memory space in accordance with information stored in the one or more shadow configuration registers.

Example 19 includes the apparatus of Example 16, wherein the second circuitry is co-located with one of the local memory and the memory device controller.

Example 20 includes the apparatus of any of Examples 15 to 19, wherein the first circuitry is further to associate respective timestamps with the plurality of per-page counters.

Example 21 includes the apparatus of Example 20, wherein the first circuitry is further to store respective per-page counter values and per-page timestamp values for the pages of the system-addressable memory space together with respective address indirection table entries in the non-system-addressable region of the local memory.

Example 22 includes the apparatus of any of Examples 20 to 21, wherein the first circuitry is further to increment a global timer value after a pre-defined period of time, and adjust one or more of the per-page counter values based on the associated per-page timestamp value and the global timer value.

Example 23 includes the apparatus of Example 22, wherein the first circuitry is further to apply a leak function to a per-page counter value based on the associated per-page timestamp value and the global timer value when a page associated with the per-page counter is accessed.

Example 24 includes at least one non-transitory machine readable medium comprising a plurality of instructions that, in response to being executed on a computing device, cause the computing device to provide a plurality of per-page counters located in a non-system-addressable region of a local memory, and count accesses to pages of a system-addressable memory space with the plurality of per-page counters located in the non-system-addressable region of the local memory.

Example 25 includes the at least one non-transitory machine readable medium of Example 24, comprising a plurality of further instructions that, in response to being executed on the computing device, cause the computing device to reporting information that corresponds to the plurality of per-page counters.

Example 26 includes the at least one non-transitory machine readable medium of Example 25, comprising a plurality of further instructions that, in response to being executed on the computing device, cause the computing device to maintaining one or more shadow configuration registers based on the contents of the one or more configuration registers of a core, and counting the accesses to the pages of the system-addressable memory space in accordance with information stored in the one or more shadow configuration registers.

Example 27 includes the at least one non-transitory machine readable medium of any of Examples 24 to 26, comprising a plurality of further instructions that, in response to being executed on the computing device, cause the computing device to associating respective timestamps with the plurality of per-page counters.

Example 28 includes the at least one non-transitory machine readable medium of Example 27, comprising a plurality of further instructions that, in response to being executed on the computing device, cause the computing device to storing respective per-page counter values and per-page timestamp values for the pages of the system-addressable memory space together with respective address indirection table entries in the non-system-addressable region of the local memory.

Example 29 includes the at least one non-transitory machine readable medium of any of Examples 27 to 28, comprising a plurality of further instructions that, in response to being executed on the computing device, cause the computing device to incrementing a global timer value after a pre-defined period of time, and adjusting one or more of the per-page counter values based on the associated per-page timestamp value and the global timer value.

Example 30 includes the at least one non-transitory machine readable medium of Example 29, comprising a plurality of further instructions that, in response to being executed on the computing device, cause the computing device to applying a leaking function to a per-page counter value based on the associated per-page timestamp value and the global timer value when a page associated with the per-page counter is accessed. Example 31 includes an apparatus, comprising means for providing a plurality of per-page counters located in a non-system-addressable region of a local memory, and means for counting accesses to pages of a system-addressable memory space with the plurality of per-page counters located in the non-system-addressable region of the local memory.

Example 32 includes the apparatus of Example 31, further comprising means for reporting information that corresponds to the plurality of per-page counters.

Example 33 includes the apparatus of Example 32, further comprising means for maintaining one or more shadow configuration registers based on the contents of the one or more configuration registers of a core, and means for counting the accesses to the pages of the system-addressable memory space in accordance with information stored in the one or more shadow configuration registers.

Example 34 includes the apparatus of any of Examples 31 to 33, further comprising means for associating respective timestamps with the plurality of per-page counters.

Example 35 includes the apparatus of Example 34, further comprising means for storing respective per-page counter values and per-page timestamp values for the pages of the system-addressable memory space together with respective address indirection table entries in the non-system-addressable region of the local memory.

Example 36 includes the apparatus of any of Examples 34 to 35, further comprising means for incrementing a global timer value after a pre-defined period of time, and means for adjusting one or more of the per-page counter values based on the associated per-page timestamp value and the global timer value.

Example 37 includes the apparatus of Example 36, further comprising means for applying a leaking function to a per-page counter value based on the associated per-page timestamp value and the global timer value when a page associated with the per-page counter is accessed.

Techniques and architectures for hardware assisted memory access tracking are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. An integrated circuit, comprising:
local memory;
a plurality of per-page counters located in a non-system-addressable region of the local memory; and
circuitry coupled to the local memory, the circuitry to:
count accesses to pages of a system-addressable memory space with the plurality of per-page counters located in the non-system-addressable region of the local memory.

2. The integrated circuit of claim 1, wherein the circuitry is further to:
report information that corresponds to the plurality of per-page counters.

3. The integrated circuit of claim 2, wherein the circuitry is further to:
maintain one or more shadow configuration registers based on the contents of the one or more configuration registers of a core; and
count the accesses to the pages of the system-addressable memory space in accordance with information stored in the one or more shadow configuration registers.

4. The integrated circuit of claim 1, wherein the circuitry is further to:
associate respective timestamps with the plurality of per-page counters.

5. The integrated circuit of claim 4, wherein the circuitry is further to:
store respective per-page counter values and per-page timestamp values for the pages of the system-addressable memory space together with respective address indirection table entries in the non-system-addressable region of the local memory.

6. The integrated circuit of claim 4, wherein the circuitry is further to:
increment a global timer value after a pre-defined period of time; and
adjust one or more of the per-page counter values based on the associated per-page timestamp value and the global timer value.

7. The integrated circuit of claim 6, wherein the circuitry is further to:
apply a leak function to a per-page counter value based on the associated per-page timestamp value and the global timer value when a page associated with the per-page counter is accessed.

8. A method, comprising:
providing a plurality of per-page counters located in a non-system-addressable region of a local memory; and
counting accesses to pages of a system-addressable memory space with the plurality of per-page counters located in the non-system-addressable region of the local memory.

9. The method of claim 8, further comprising:
reporting information that corresponds to the plurality of per-page counters.

10. The method of claim 9, further comprising:
maintaining one or more shadow configuration registers based on the contents of the one or more configuration registers of a core; and
counting the accesses to the pages of the system-addressable memory space in accordance with information stored in the one or more shadow configuration registers.

11. The method of claim 8, further comprising:
associating respective timestamps with the plurality of per-page counters.

12. The method of claim 11, further comprising:
storing respective per-page counter values and per-page timestamp values for the pages of the system-addressable memory space together with respective address indirection table entries in the non-system-addressable region of the local memory.

13. The method of claim 11, further comprising:
incrementing a global timer value after a pre-defined period of time; and
adjusting one or more of the per-page counter values based on the associated per-page timestamp value and the global timer value.

14. The method of claim 13, further comprising:
applying a leaking function to a per-page counter value based on the associated per-page timestamp value and the global timer value when a page associated with the per-page counter is accessed.

15. An apparatus, comprising:
a core;
a local memory; and
a memory device controller coupled to the core and the local memory, the memory device controller including first circuitry to:
count accesses to pages of a system-addressable memory space with a plurality of per-page counters located in a non-system-addressable region of the local memory.

16. The apparatus of claim 15, further comprising:
second circuitry to report information that corresponds to the plurality of per-page counters.

17. The apparatus of claim 16, wherein the second circuitry is co-located with the core.

18. The apparatus of claim 17, wherein the core further comprises one or more configuration registers, the memory device controller further comprises one or more shadow configuration registers, and wherein the first circuitry is further to:
maintain the one or more shadow configuration registers based on the contents of the one or more configuration registers; and
count the accesses to the pages of the system-addressable memory space in accordance with information stored in the one or more shadow configuration registers.

19. The apparatus of claim 16, wherein the second circuitry is co-located with one of the local memory and the memory device controller.

20. The apparatus of claim 15, wherein the first circuitry is further to:
associate respective timestamps with the plurality of per-page counters.

21. The apparatus of claim 20, wherein the first circuitry is further to:
store respective per-page counter values and per-page timestamp values for the pages of the system-addressable memory space together with respective address indirection table entries in the non-system-addressable region of the local memory.

22. The apparatus of claim 20, wherein the first circuitry is further to:
increment a global timer value after a pre-defined period of time; and
adjust one or more of the per-page counter values based on the associated per-page timestamp value and the global timer value.

23. The apparatus of claim 22, wherein the first circuitry is further to:
apply a leak function to a per-page counter value based on the associated per-page timestamp value and the global timer value when a page associated with the per-page counter is accessed.
